(19) United States
(12) Patent Application Publication
(10) Pub. No.: US 2023/0319037 A1
(43) Pub. Date: Oct. 5, 2023

(54) SYSTEM AND METHOD FOR FULLY DISTRIBUTED AND DECENTRALIZED COMMUNICATION

(71) Applicant: Telesola Corporation, Ottawa (CA)

(72) Inventors: Marzia ZAMAN, Nepean (CA); Goutam SHAW, Ottawa (CA); Srinivas SAMPALLI, Hammonds Plains (CA)

(21) Appl. No.: 18/127,914

(22) Filed: Mar. 29, 2023

Related U.S. Application Data
(60) Provisional application No. 63/324,808, filed on Mar. 29, 2022.

(51) Int. Cl. H04L 9/40; H04L 67/141

(52) U.S. Cl. CPC H04L 63/0876; H04L 67/141; H04L 63/04

(57) ABSTRACT

A communication system is described that is implemented in a distributed manner. The system uses self-executing code that executes on a distributed ledger technology network to retrieve connection information that can be used in establishing a communication session.

### RELATED APPLICATIONS

The current application claims priority to U.S. Provisional Patent Application 63/324,808 filed Mar. 29, 2023, the entire contents of which are incorporated herein by reference.

### TECHNICAL FIELD

The current application relates to systems and methods for user communications, and in particular to systems and methods for fully distributed and decentralized communication.

### BACKGROUND

Commonly used real-time and non-real time communication systems are typically client-server based. The centralized server based communication impose a significant risk to the clients. Denial of service/distributed denial of service attacks are among many issues that can affect the server-client based system and thereby the clients. Also, the well-known and heavily used communication systems such as Skype, Teams, Zooms, etc. are based on storage of critical information of the users on the server which concerns many users about the privacy of their data, especially since the data may be stored in jurisdictions outside their country. Furthermore, in many of these systems, end-to-end encryption of data is not possible. Data transparency is also not present in many of these applications. Both privacy and security are of great concerns for many applications that require real-time and non real-time private communication and data storage such as in virtual healthcare applications where the physician may need to have a consulting session with their patient or with other physicians virtually and/or have access to patient's medical information.

It would be desirable to have a communication system that can provide users with improved privacy and security while being robust against attacks.

### SUMMARY

In accordance with the present disclosure there is provided a communication method comprising: receiving, at a first user device, an indication of a participant for participation in a communication session; accessing, by the first user device, at least one code contracts comprising self-executing code executing on a DLT to retrieve connection information of the participant stored on the DLT; and attempting, by the first user device, to establish a communication session with a second end user device of the participant using the retrieved connection information.

In a further embodiment of the communication method, the method further comprises: receiving user information of a new user, the user information including connection information for the new user; determining an initial trust score of the new user; accessing the at least one code contract executing on the DLT to store the user information and the initial trust score of the new user on the DLT.

In a further embodiment of the communication method, the method further comprises: determining a dynamic trust score of the new user based on one or more communication sessions of the user; and accessing the at least one code contract executing on the DLT to store the dynamic trust score of the new user on the DLT.

In a further embodiment of the communication method, determining the dynamic trust score of the new user based on one or more communication sessions of the new user comprises: adjusting the initial trust score according to trust scores of users of successfully established communication sessions with the new user; and adjusting the initial trust score according to trust scores of users of rejected communication sessions with the new user.

In a further embodiment of the communication method, the method further comprises: determining updated connection information for a particular user having user information stored on the DLT; and accessing the at least one code contract executing on the DLT to update the connection information of the particular user stored on the DLT.

In a further embodiment of the communication method, the communication session comprises one or more of: a SIP based communication session; a Voice over IP communication session; a Video over IP communication session; and an instant message communication.

In a further embodiment of the communication method, the connection information comprises an IP address and port number.

In a further embodiment of the communication method, the connection information further comprises encryption information.

In accordance with the present disclosure there is further provided a non transitory computer readable medium storing instructions for execution on at least one computing device to configure the at least one computing device to perform any of the embodiments of the methods described above.

### BRIEF DESCRIPTION OF THE DRAWINGS

In the accompanying drawings, which illustrate one or more example embodiments:

FIG. 1 depicts components of a fully distributed communication system;

FIG. 2 depicts DLT components of a fully distributed communication system;

FIG. 3 depicts details of components of a fully distributed communication system;

FIG. 4 depicts end user communication devices for use in a fully distributed communication system;

FIG. 5 depicts details of a trust management component used in a fully distributed communication system;

FIG. 6 depicts a process of using a trust management component;

FIG. 7 depicts details of a communication component;

FIG. 8 depicts a contact management and security management components;

FIG. 9 depicts details of a decentralized communication component used in a fully distributed communication system;

FIG. 10 depicts an identity management component;

FIG. 11 depicts a process for registering a user in a fully distributed communication system;

FIG. 12 depicts a process for registering a message with the DLT network;

FIG. 13 depicts a process for requesting callee identification information in a fully distributed communication system;

FIG. 14 depicts a process for initiating real-time communication;

FIG. 15 depicts a process of rejecting a communication session in a fully distributed communication system; and

FIG. 16 depicts a process for providing a service session in a fully distributed communication system

### DETAILED DESCRIPTION

A fully distributed and decentralized communication system is described further below which does not rely on centralized servers for communication sessions. The fully distributed and decentralized communication system makes use of a Distributed Ledger Technology (DLT) network or use other similar technology to store and lookup on the DLT user information including connection information such as an IP address, port, for use in establishing a secured communication session. The communication system also incorporates trust score associated with users that allow users to control which different users can establish communication sessions with them. The fully distributed and decentralized communication system makes use of the DLT for distributed storage and access to user information including connection information that can be used in establishing communication sessions, which may be done using for example peer-to-peer communication technologies. In addition to the ability to store and lookup user information, the DLT network can also self-executing code, which may be provided as one or more code contracts, to provide a wide range of functionality. As described further below, the self-executing code on the DLT network can be used to provide code contracts that provide a level of trust for users of the distributed and decentralized communication system.

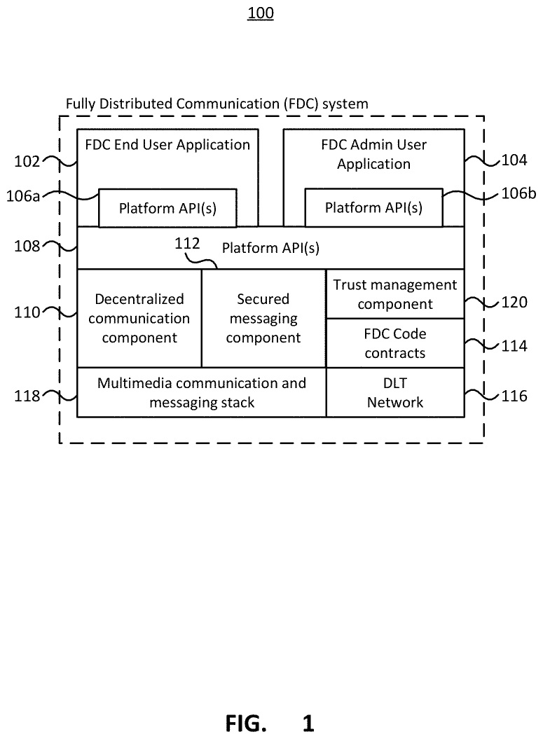

FIG. 1 depicts components of a fully distributed communication system. The fully distributed communication (FDC) system 100 may include both end user applications 102 and admin user applications 104. Both applications may be executed on one or more computing devices and provide a user interface for interacting with the system, such as making, accepting, declining and ending calls, sending and receiving messages, etc. Each of the applications 102, 104 include platform APIs 106a, 106b that allow the applications to interact with the communication platform through platform API(s). It will be appreciated that the platform API(s) 106a, 106b are a part of the API(s) 108 that allow the applications to call the API functionality.

The platform API(s) may provide a programming interface to other functionalities including for example decentralized communication functionality 110, and secured messaging component 112. Both the communication and messaging components may be built on a multimedia communication and messaging stack 118 that allows the components to establish communication sessions with other devices. The communication sessions may be real-time communication sessions such as audio/video calls, as well as non-real-time communication sessions such as instant messaging. The communication session may include additional functionalities such as screen sharing, presentations, etc. The decentralized communication component 110 and secured messaging component 112 may establish a communication session with a desired user or users and may use code contracts 114 provided by self-executed code that is executing on the DLT 116 to determine the connection information of the user or users.

The communication system 100 may also provide trust management functionality for users. The trust management functionality 120 may allow a trust score for users to be determined and used for allowing different actions within the system. For example, a user may set a trust score threshold for users that can establish a communication session with them. Users that do not meet or exceed the trust threshold may not call or otherwise contact the user. The trust management component may initially determine a trust score when a user is registered in the communication system. The initial trust score may be based on various information on the user such as current employer, age, employment history, as well as other information that may be publicly available or provided by the user. The user's trust score may be updated dynamically based on updated information used in the initial trust score determination as well as interactions of the user with the communication system. For example, if a user establishes multiple communication sessions with a trusted individual, the user's trust score may be increased. Similarly, if the user shows undesirable behaviours such as making spam calls, the user's trust score may be decreased. Users of the communication system are unable to update his/her own trust score.

The communication system may use decentralized applications on the front-end and code contracts at the back-end to communicate with the DLT. Confidential data is secured between parties involved in the communication whereas other data e.g. data required for address resolution will be exchanged between the parties participating in communication through the DLT. Using the described communication system, there is no need for signalling server and/or media server that are typical in a traditional real-time communication system. Both real-time and non-real-time communication is possible using the current communication system.

Additionally, different AI enabled systems can be developed using the communication system that have high privacy and security requirements. For example, medical service providers can automate their service using the proposed communication platform. Identity management, privacy preservation and end-to-end encryption for communications are part of the communication system, allowing different services to be implemented.

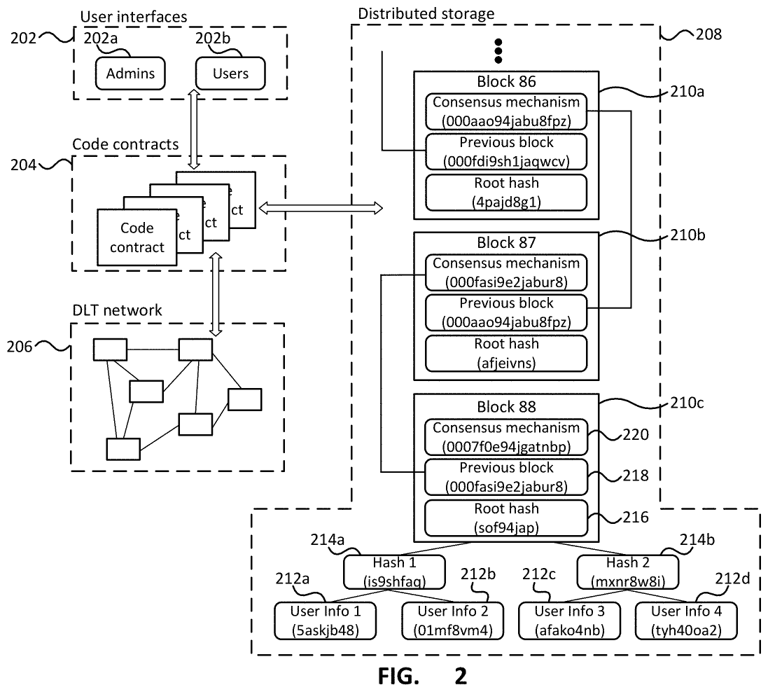

FIG. 2 depicts DLT components of a fully distributed communication system. The system comprises one or more user interfaces 202 that can interact with a block chain via various code contracts 204 that provide various functionality by self-executing code that can be executed by the DLT network. The user interfaces 202 may include, for example, administration interfaces 202a that may be used by administrators of the system as well as interfaces of users. The interfaces 202 are executed off the DLT and may be provided on computing devices. The code contracts 204 may be executed on a DLT provided by a plurality of DLT nodes 206. The DLT 208 may be a public or private DLT and is provided by a plurality of nodes which are each computing devices capable of implementing the DLT protocol. The nodes may include different types of nodes including for example bootstrap nodes which are nodes that are always present and allow additional nodes to be added to the DLT. While there are different digital ledger technologies, as an example, the code contracts may be realized using Ethereum blockchain's Smart Contract technology. In the Ethereum blockchain, all of the nodes of the blockchain network run the Ethereum virtual machine (EVM) and executes the same instructions. Each of the nodes receives transactions, which may include for example user information and information about user interactions, to be stored and attempts to add the transactions to the DLT 208. The DLT comprises a number of blocks 210a, 210b, 210c with each block linked to the previous block by a one-way cryptographic function. Each block stores transactions, depicted as user information 212a, 212b, 212c, 212d, or representations of the transactions which may include a cryptographic hash of the transaction. The transactions may be stored in the leaf nodes of a Merkle tree or hash tree. Pairs of the leaf nodes can be hashed and stored as another layer of the tree 214a, 214b. The Merkle tree, may be stored as a root hash in a block 216 for storing the transactions. In addition to the transactions, the block may include a cryptographic hash representation of the previous block 218. The block includes a consensus mechanism 220, such as proof of work, which can be generated by concatenating the root hash of the transactions 216, previous block pointer 218 and a nonce (not shown). The proof of work may be done by repeatedly changing the nonce value and taking the cryptographic hash until the hash value begins with a predetermined value. For example, the proof of work may require determining the nonce value that will produce a hashed value beginning with three 0s. By changing the number of leading 0s, or the length of the predetermined value, the difficulty of the proof of work can be varied. Once the nonce value producing the predetermined value, such as ‘000’, for the hash value, the block can be added to the DLT. The proof of work hash value of a parent block may be used to link the next block. Since each block is linked using a cryptographic hash based on a previous block's hash and the current transactions, the blocks and transactions in the DLT cannot be modified, since any attempt to modify blocks can be identified.

The above has described use of a cryptographic proof of work as the consensus mechanism for adding blocks to the DLT. However, it is possible that other consensus mechanisms may be used, such as a proof of stake consensus mechanism. In proof of work mechanisms, many ‘miners’ compete to find the hashed value. All of the computing, and associated electricity, done by the miners that were not successful in finding the hashed value is wasted. In proof of stake mechanism ‘validators’ which are similar to miners pay an amount into the network, their ‘stake’ and one of the validators is selected at random with the probability based on the amount of stake the validator has. The selected validator may then generate the hashed value for the block, which does not require determining the nonce to prove the work, and add the block to the DLT. The proof of stake consensus mechanism avoids the large amount of wasted computations performed by proof of work. It will be appreciated that the proof of work or proof of stake consensus mechanism may be used in the DLT, or alternative consensus mechanisms could be used such as proof of capacity, proof of activity, proof of burn, etc.

The DLT network can execute code contracts 204 that provide various functionality including functionalities used by the fully decentralized communication system. Each code contract 204 is program code that is executed on the DLT network. The code contract is a collection of code function(s) and data providing the code contract's state. Each code contract may be a type of DLT account and resides at a specific address on the DLT. Code contracts may have a balance and can send transactions over the DLT network. However, rather than being controlled by a user, code contracts may be deployed to the network and run by the DLT nodes as programmed. User accounts can interact with a code contract by submitting transactions that execute a function defined by the code contract. Code contracts can define rules, like a regular contract, and automatically enforce them via the code. As described further below, a number of different code contracts can be provided that help provide the communication system using the DLT.

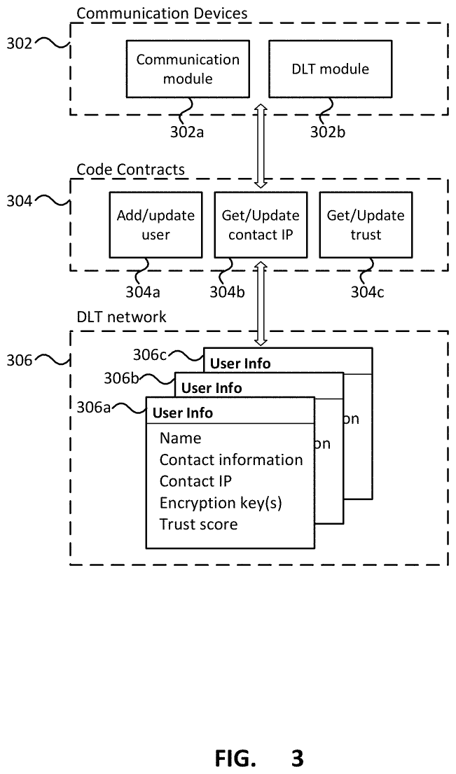

FIG. 3 depicts details of DLT components of a fully distributed communication system. One or more communication devices 302 may be used, for example by an end user or administrator, within the communication system. The communication devices 302 may implement the administration interface and/or the user interface similar to that described above with reference to FIG. 2. The communication devices may include, for example, a communication module 302a and a DLT module 302b. The communication module 302a may provide functionality for establishing communications, which may be either real-time or non-real-time, with other devices. The communication module 302a may require information stored on the DLT when establishing communications and may use the DLT module 302b to retrieve the required information. The communication module 302a may also provide information to the DLT 302b including for example providing contact information such as an IP address of the device. The DLT module of the communication devices may use different code contracts 304 that can be executed on the DLT in order to store and/or access information on the DLT. As depicted, the code contracts may code contracts for adding and/or updating user information 304a, getting and/or updating contact addresses 304b such as an IP address, and getting and/or updating trust scores of a user 304c. It will be appreciated that these code contracts are intended to be illustrative and additional code contracts may be included. The code contracts can provide functionality for evaluating the trust of users of the system

Regardless of the particular code contracts, user information may be created, read, updated on the DLT 306. As depicted, the DLT may store user information for different users 306a, 306b, 306c that can be used for communicating with the user. The information may include, for example, user name or other identifier, contact information which may include various user names or alias as well as contact IP information. Although only contact IP address is depicted it will be appreciated that the contact IP address may also specify a port associated with the contact IP used for communicating with the user. Additionally, although only a single contact IP address is depicted, it is possible to include multiple IP addresses. The user information may further include additional information such as encryption keys for the user as well as their trust score. The user information may be stored on the DLT as transactions within the blocks. However, since a block is immutable, when updating a user's information, a new user information may be stored, or possibly only those portions that have changed.

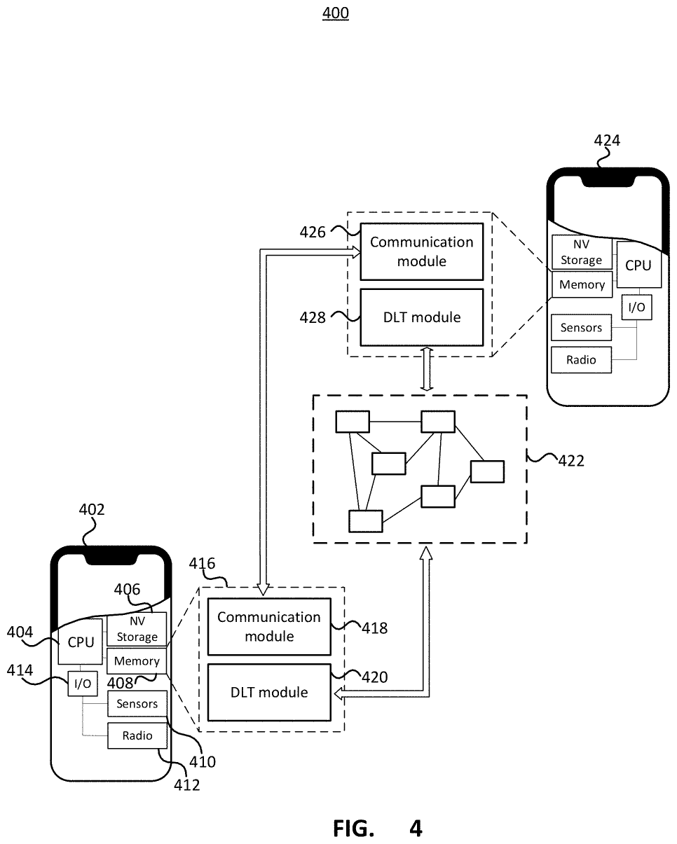

FIG. 4 depicts end user communication devices for use in a fully distributed communication system. The communication system 400 includes a first end user communication device 402, which is depicted as a mobile phone although other computing devices can be used as the end user device. The end user device 402 comprises a processing unit 404 capable of executing instructions. The instructions, and other data, may be stored in non-volatile storage 406 as well as memory 408. The end user device 402 may further comprises one or more sensors 410 as well as one or more radios 412 or modems. The radios/modems may be wired or wireless radios/modems used for communicating with other devices. The radios/modems and sensors when present may be communicatively coupled to the processing unit 404 through one or more input/output (I/O) interfaces 414.

The instructions stored in memory 408 may be executed by the processor 404 to configure the end user device to provide various functionality 416. The functionality provided by executing the instructions include a communication module functionality 418 and DLT module functionality 420. The functionality 418, 420, which is described in further detail below, allows the end user device to establish communications with other end user devices of the communication system 400 using a DLT 422. A second end user device 422 is depicted and similar to end user device 402, may comprise a processing unit, non-volatile storage, memory, sensors, radios/modems and I/O interfaces. Instructions stored in the memory when executed by the processor configure the second end user device 422 to provide communication module functionality 426 and DLT module functionality 428 for use in participating in the communication system 400.

When a first user (“User A”) of end user device 402 wishes to establish a communication session (referred to further below as a call for brevity) with a second user (“User B”) that uses end user device 424, User A enters some identifying information, such as a name, nickname, email, etc. of User B. The DLT module of user device 402 accesses the DLT 422 using one or more code contracts in order to retrieve connection information of User B. The code contracts may search the DLT for user information matching the identifying information of User B. It will be appreciated that in this example, it is assumed that User B has been registered with the communication system so that the connection information, such as an IP/port of the user device 424 as well as possibly encryption information, of User B is stored and accessible on the DLT 422. Once the connection information is retrieved from the DLT, the information may be used by the communication module 418 in establishing the call with the user device 424, or more particularly the communication module 426 of the user device 424. For example, the connection information may be used to establish a call with directly with the user device 424 using the IP/port for User B. All communication over the DLT network can use a channel secured using encryption.

The above has described establishing a call between users by using a DLT to provide address resolution. Although not described in the example above, the communication system may also make use of trust scores for users to provide users an improved process for verifying possibly unknown users or other entities. When a user or entity registers with the communication system, an initial trust score may be determined for the user based on various information. Once an initial trust score is established, it may be dynamically adjusted based on the user's actions, whether with the communication system and other users of the communication system or with external systems. The trust score may be used in establishing communication sessions. The user may set trust score thresholds for calls that may be automatically blocked, manually blocked or declined as well as allowed. That is, if a user's trust score is below a set threshold, the call may be automatically blocked without notifying the callee. Additionally or alternatively, the trust score may be presented to the callee in order to help the callee decide how to handle the call.

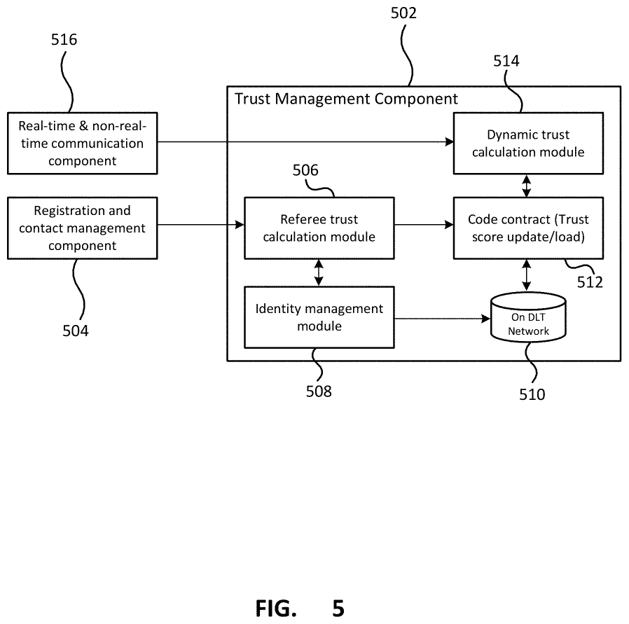

FIG. 5 depicts details of a trust management component used in a fully distributed communication system. The trust management component 502 may comprise various functionality as shown in FIG. 5. The trust management component calculates and stores a trust score for all application users. The trust score may be determined using a consensus mechanism. A user may not be able calculate and/or store his/her own trust score. An end user communication application may query the trust score stored on the DLT. The trust score may have two components (i) Initial Trust Score (ii) Dynamic Trust Score. The initial trust score may be calculated based on user's interactions through his/her communication app with other communication apps developed by certified authorities. The more authorities the user's communication app user authenticates with, the higher is the score. Once initial threshold score is met, and so the user becomes an eligible user, the user can use his/her communication app to communicate with other eligible users including different service providers' communication app developed using communication platform described herein. The trust score will be dynamically updated as user interacts with other reputed (high trust score) users. The trust score threshold can be set by the particular communication user applications to be eligible to communicate with.

The trust management component 502 may interact with a registration and contact management component 504, which may be part of an administration application or part of the end user application. Regardless, the registration and contact management component 504 provides information to the trust management component including for example user name, information about user accounts, employment information, encryption information, etc. The registration information may be used by a referee trust score calculation module 506 that uses the received information to determine the initial trust score for the user. The user information may also be passed to an identity management module 508 that creates, and possibly updates, user accounts for the communication system. The identity management module 508 may store and retrieve the user account information on the DLT 510, possibly using a code contract (not shown). The initial trust calculation module 506 may uses a code contract 512 for storing or updating user trust scores on the block chain. In addition to determining the initial trust score, the trust management component may also include a dynamic trust calculation module 514 that dynamically updates the user's trust score. The dynamic trust score calculation module 514 may receive information about the user's interactions with the communication component, such as other user's they communicate with, the number of communication sessions established or attempted to be established, etc. The information for updating the trust score may be provided from a real-time and non-real-time communication component 516 that is used in establishing real-time and non-real-time communication with other users. Once the dynamic trust calculation module 514 determines the user's dynamic trust score, it uses the code contracts 512 to store the updated dynamic trust score on the block chain.

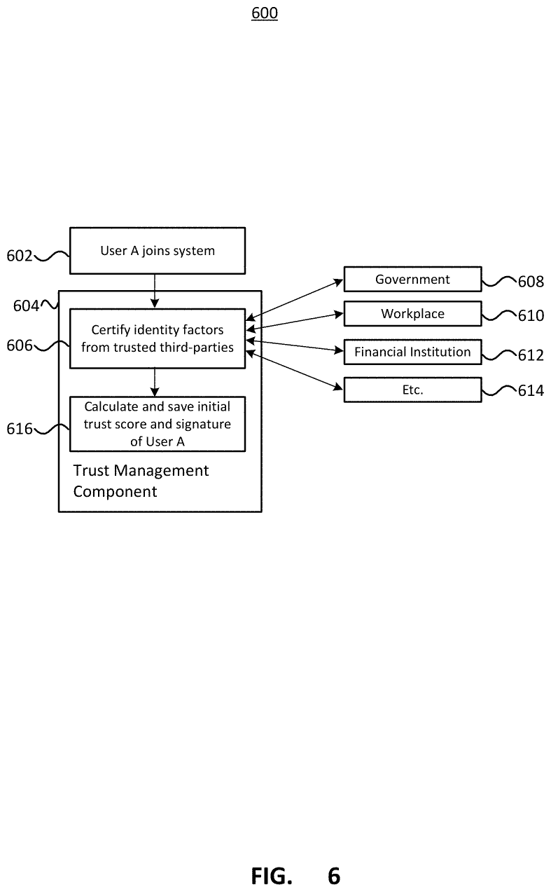

FIG. 6 depicts a process of using a trust management component. As depicted in the process 600, a user, User A, joins the system 602 and the trust management component 604, certifies identity factors provided by the user in the registration process. The identity factors may be certified from trusted third parties using appropriate APIs 606. The trusted third parties may include a wide range of entities including for example, governments 608, workplaces 610, financial institutions 612, and other trusted or authorized entities 614. Once the user's identity factors are certified, the initial trust score can be calculated and stored as a signature for the user on the DLT 616.

User will be successfully registered to the DLT network upon receiving sufficient trust score from the authorities and at that point become eligible user of the DLT communication network. Service providers using this communication system may require additional trust score for certain services that can be only acquired through successful interaction with their communication apps. For example, a user app may choose to create a contact list only if the trust score of a contact meets a specific threshold and/or block users based on the contact's trust score. In addition, user's identity signature with different authorities may be collected and stored in the DLT and an authority or service provider may ask users for digital identity. Restrictions in the communication system may be provided based on the user identity information. For example, only users with appropriate privileges and signed identity can use services from the other communication applications.

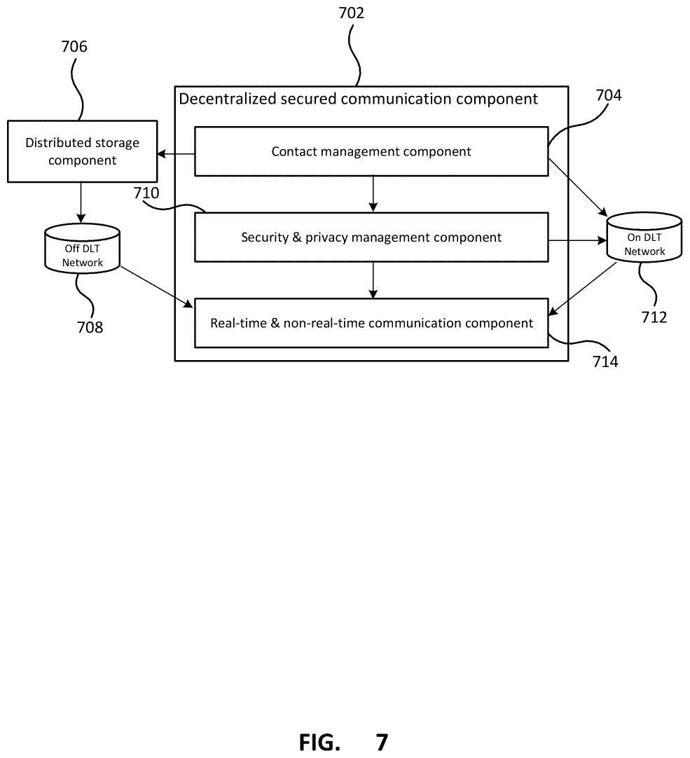

FIG. 7 depicts details of a communication component. A decentralized secured communication component 702 may include contact management component 704 that can communicate with a distributed storage component 706 to store contact information off the DLT network 708, or possibly on the DLT network 712. The contact management component 704 may provide functionality for managing a user's contacts such as names, contact information, call history, etc. A security and privacy management component 710 may storage and access security/privacy information to the DLT network 712 using one or more code contracts. The security/privacy information may include one or more encryption keys that may be used in securing communication with the user. A real-time and non-real-time communication component 714 may be provided that can establish communication sessions with other users. The contact information for use in establishing the communication sessions may be stored on or off the DLT network and may be provided by the contact management component. Additionally, the communication component may use information provided from the security and privacy management component, such as encryption keys for the user, and possibly for the party being contacted.

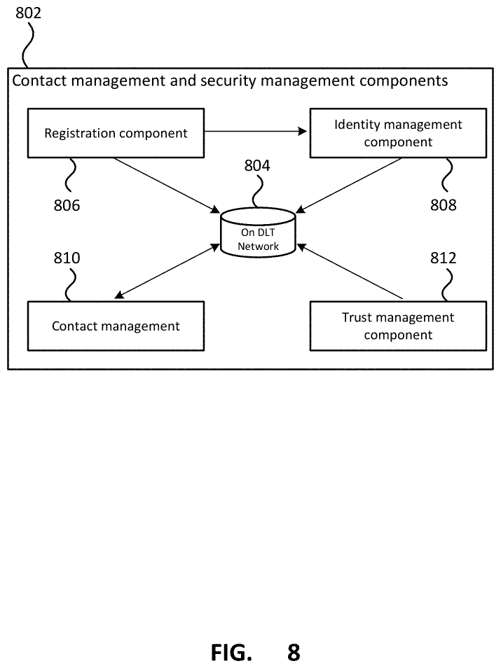

FIG. 8 depicts a contact management and security management components 802. Various components can access the DLT network 804 to store and retrieve information. The interaction with the DLT network may be performed using code contracts executing on the DLT network. The components may comprise a registration component 806 that registers a user with the communication system. An identity management component 808 may allow a user to manage their identity information that may be stored on the DLT network 804. The registration component may interact with the identity management component when registering a user with the communication system. A contact management component 810 may be used to manage a user's contacts and associated information. The contact information may be stored on the DLT network, or may be stored off the DLT network. A trust management component 812 may be used to determine a trust score associated with individuals. The trust score associated with individuals may be stored on the DLT network.

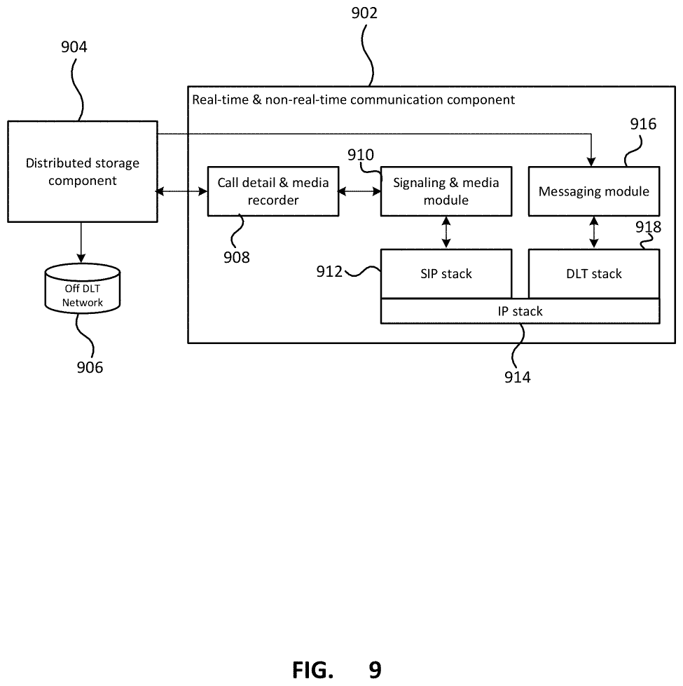

FIG. 9 depicts details of a decentralized communication component used in a fully distributed communication system. The Decentralized Communication Component (DCC) 902 may be implemented on end user devices, for example as part of the communication and DLT modules described above. The DCC 902 may implement the real-time communication i.e. audio/video calls as well as chat features of the end user communication application. The DCC 902 may use a distributed storage component 904 for storing information off of the DLT 906. This distributed storage may include storage of information such as user preferences, contact lists, settings, call recordings, etc. The DCC 902 may include a call detail and media recorder component 908 that may be used to store and/or access off-chain information such as storing call recordings, or accessing user preferences for displaying call details.

A signalling and media module 910 may responsible for the real-time communication. signaling and media module 910 may use other communication stacks for establishing the communication. For example, the signaling and media module 910 may use a Session Initiation Protocol (SIP) stack 912, which in turn may use an IP stack 914, for signalling without requiring a SIP proxy or registration or media server. Rather than relying on a SIP proxy or registration or media server, the signaling and media module may perform remote party address resolution using a messaging module 916 that accesses information on the DLT 918. The messaging module may be used to establish secured/encrypted communication between multiple users using the signalling a media module. Thus privacy is preserved, as no server is involved.

The messaging module may be responsible for light-weight secured/encrypted communication between users. The messaging module may provide API(s) to other components as well as using other components, such as a Secured Messaging Component of the communication system described above with reference to FIG. 1. A secured messaging component may use a publish/subscribe design pattern. For example, any communication application of the system that implements a secured chat feature can subscribe to a predefined topic and engage in public/group conversation or private conversation using the public key cryptography. Also, for real-time communication a different topic and key-pair can be used to share SIP Uniform Resource Identifier (URI) information between caller and called parties.

In order to perform Network Address Translation (NAT) address resolution, which may be required to establish communication with devices behind a firewall, an out of band signalling/technology can be used. For example, a light-weight stun server may be made part of the system, such as part of the nodes of the DLT. The out of band signalling technology may use, for example the UPnP protocol and/or a custom protocol. Further, public keys used for encrypting and authenticating the message between the communicating parties can also be stored in the DLT when end-user communication apps start and can be updated (to get a fresh key) at a regular interval.

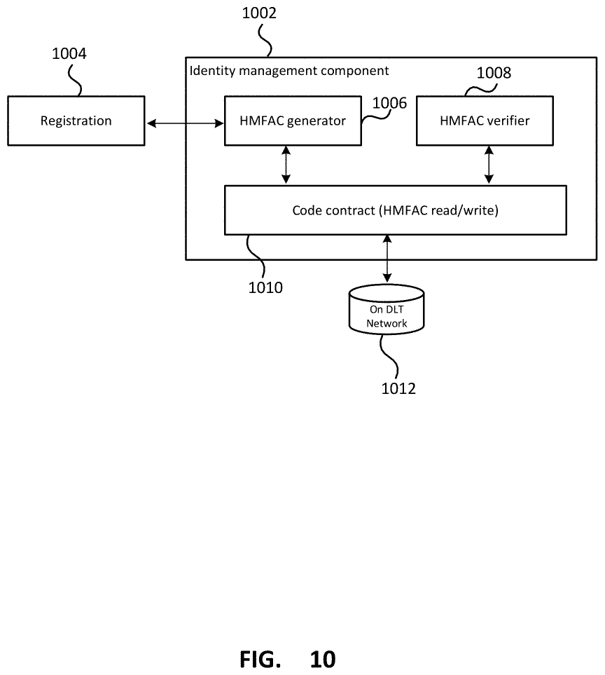

FIG. 10 depicts an identity management component 1002. The identity management component may be used by a registration component 1004 in order to create a user's identity when registering a user with the communication system. An HMFAC (hash of multifactor authentication codes) generator 1006 may be used to generate an HMFAC used for identifying/verifying a user's identity. An HMFAC verifier component 1008 may authenticate or verify provided HMFACs. A code contract 1010 that executes on the DLT network 1012 may be used that reads and/or writes HMFACs from and/or to the DLT network.

The above has described a communication system that is able to establish communication sessions between users without requiring a server. The system uses a DLT network for use in establishing the communication sessions. The use of the DLT provides privacy-preserving address resolution. Further, the communication system may provide a process for automated and democratic community based user trust calculation and update using the DLT, which may also provide for identity management for the real-time and non real-time communication and data storage with enhanced privacy. The communication system may provide a true peer-to-peer multi-media over IP solution with end to end (point to point) encryption by combining DLT technology and SIP signalling protocol. The system uses the DLT for solving user identity and trust, which builds trust in the system and users democratically. Further, the cryptographic DLT can ensure no identity theft can occur. The system uses SIP's inherent peer-to-peer protocol infrastructure however it relies on DLT for physical address resolution and access. The communication system is not only for VoIP but also applies to all media related communication that offers decentralized media communication along with decentralized media storage on the endpoints participating in DLT network. The communication system allows entities and users to build the users' trusted network for all media communications, including for example real time audio/video and messaging enabling exchange of media without the baggage that comes with the centralized systems such as leaking of privacy information, unwanted solicitation, etc. The system is highly scalable and can provide APIs for building decentralized applications, possibly with AI enabled service offerings.

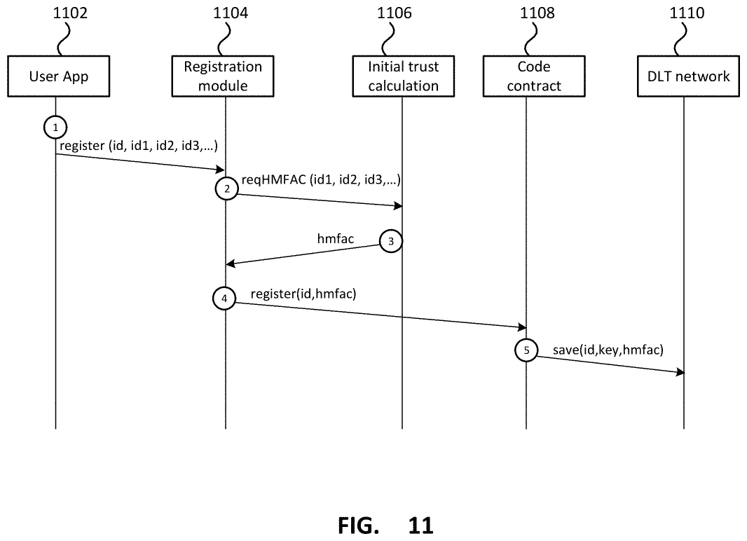

FIGS. 11-16 depict various use case processes for communication using a communication system as described above.

FIG. 11 depicts a process for registering a user in a fully distributed communication system. A user may use the end user or an administration application 1102 to provide information, such as a user identifier for the communication system, and one or more IDs of other systems, to a registration module 1104 that may call the trust calculation module 1106 to determine trust scores associated with the user IDs from the other systems. The trust scores may be provided back to the registration module as a hash of multi factor authentication code (HMFAC) such as hash (id1, id2, . . . ). The trust score of HMFAC may then use one or more code contract 1108 to register the user with the user ID into to the communication system and store the information to the DLT network 1110.

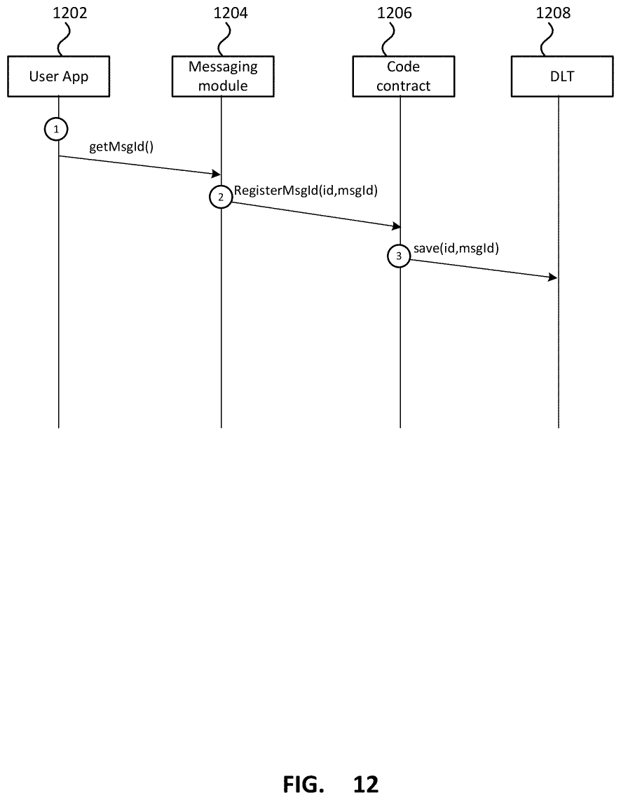

FIG. 12 depicts a process for registering a message with the DLT network. A user may use the user app 1202 to get an ID for a message. The messaging module 1204 may provide the message ID, along with the user's ID to a code contract 1206 that stores the message ID and user ID on the DLT network 1208.

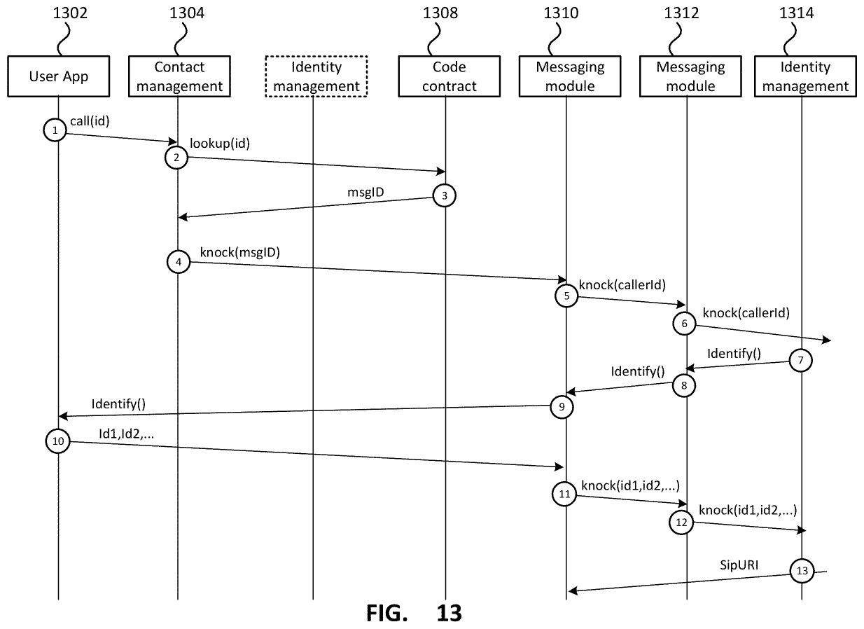

FIG. 13 depicts a process for requesting callee identification information in a fully distributed communication system. A user may use an end user app 1302 to start a call with a second user. The callee's ID is provided to a contact management module 1304, which uses a code contract 1308 to lookup the contact information for the callee, which may be provided back to the contact management module. The contact management module may use the contact information to establish a call with the second user. The contact information is passed to the messaging module 1310 of the caller which attempts to establish a call with the messaging module 1312 of the callee's device. The messaging module, or an administration module of the callee's device may pass the first users information to the identity management module 1314 of the callee's device, which may require that the caller verify their identity, which passes the identification request back to the first end user's app, which can then respond through the messaging modules with appropriate identification. Assuming the callee wishes to establish the call with the caller, the SIP URI may be returned back to the caller for establishing the call.

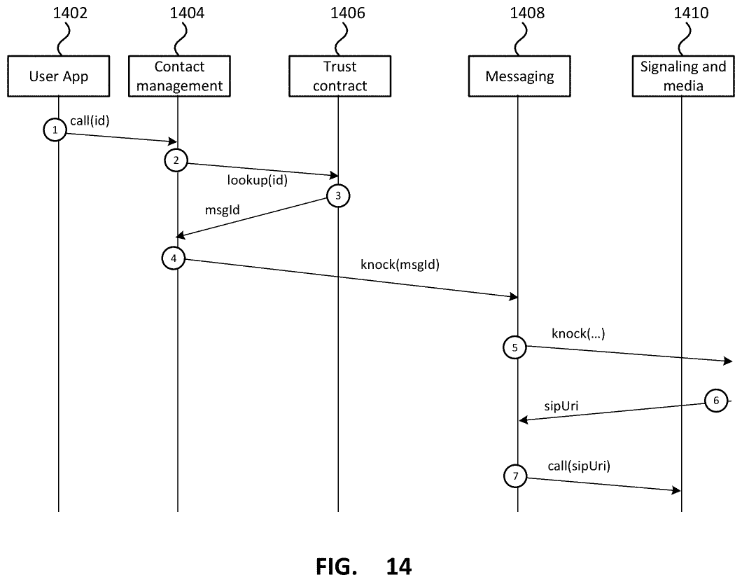

FIG. 14 depicts a process for initiating real-time communication. A user may use an app 1402 to send a call request with an identifier of the callee party. The call request may be sent to a contact lookup module 1404 that lookups the trust information associated with the user's ID. The trust information may be retrieved from the DLT network using a code contract 1406 provided by one or more code contracts executing on the DLT network. A message identifier provides the user's trust information. A call is establish by sending a knock message from a messaging module 1408 with the trust information. If the called party wishes to respond to the knock request, a SIP URI may returned and used by a signalling and media module 1410 to establish a real-time communication session.

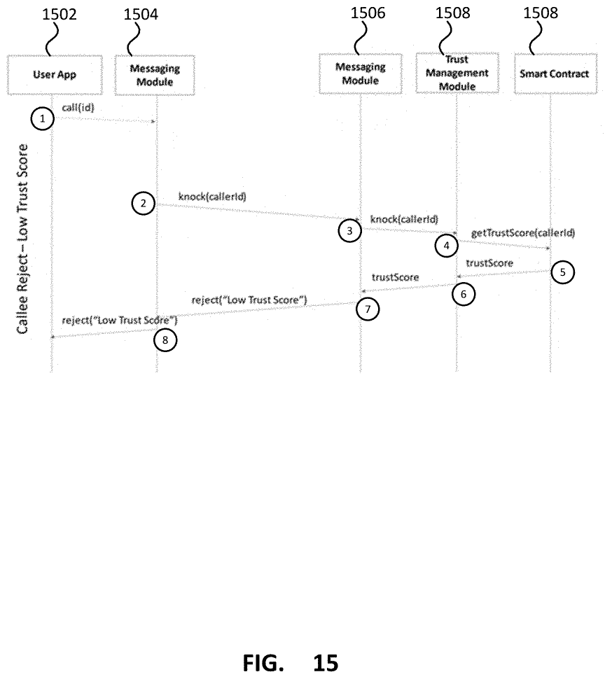

FIG. 15 depicts a process of rejecting a communication session in a fully distributed communication system. The process begins with a caller's end-user app 1502 attempting to establish a call using the caller's messaging module 1504 and the messaging module of the callee 1506. The callee's messaging module passes the caller's information to the trust management module 1508, which may use a code contract to retrieve the caller's trust score. Assuming the trust score is below a threshold, the call may be rejected for being too low of a trust score and the caller may be notified of the rejection.

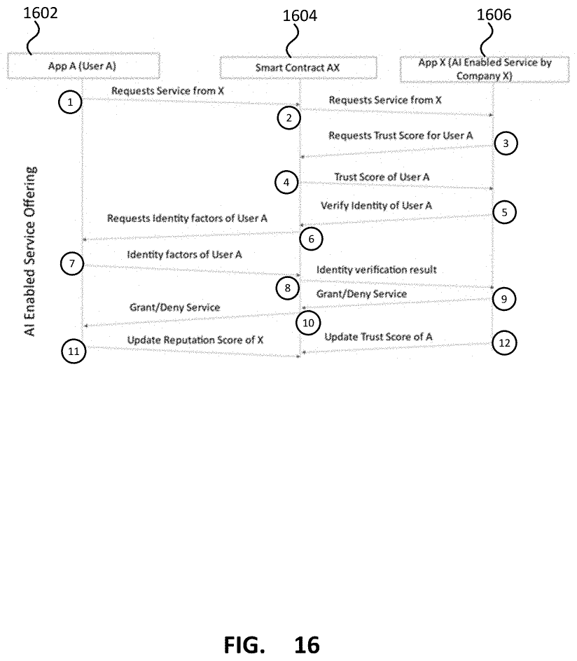

FIG. 16 depicts a process for providing a service session in a fully distributed communication system. The process may begin with a user using a communication app 1602 to request a service provided by an entity “X”. The request may use one or more code contracts 1604 for accessing the service, which may forward to the request to the application providing the service 1606. The service may use the code contracts to obtain the trust score of the user and requests the user to verify their identity through one or more code contracts. The user may provide the identity information that can allow the service to grant or deny the service to the user. The reputation/trust score of the service and the user may be updated based on the interaction.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A communication method comprising:
receiving, at a first user device, an indication of a participant for participation in a communication session;
accessing, by the first user device, at least one code contracts comprising self-executing code executing on a distributed ledger technology network (DLT) to retrieve connection information of the participant stored on the DLT; and
attempting, by the first user device, to establish a communication session with a second end user device of the participant using the retrieved connection information.

2. The communication method of claim 1, further comprising:
receiving user information of a new user, the user information including connection information for the new user;
determining an initial trust score of the new user;
accessing the at least one code contract executing on the DLT to store the user information and the initial trust score of the new user on the DLT.

3. The communication method of claim 2, further comprising:
determining a dynamic trust score of the new user based on one or more communication sessions of the user; and
accessing the at least one code contract executing on the DLT to store the dynamic trust score of the new user on the DLT.

4. The communication method of claim 3, wherein determining the dynamic trust score of the new user based on one or more communication sessions of the new user comprises:
adjusting the initial trust score according to trust scores of users of successfully established communication sessions with the new user; and
adjusting the initial trust score according to trust scores of users of rejected communication sessions with the new user.

5. The communication method of claim 1, further comprising:
determining updated connection information for a particular user having user information stored on the DLT; and
accessing the at least one code contract executing on the DLT to update the connection information of the particular user stored on the DLT.

6. The communication method of claim 1, wherein the communication session comprises one or more of:
a SIP based communication session;
a Voice over IP communication session;
a Video over IP communication session; and
an instant message communication.

7. The communication method of claim 1, wherein the connection information comprises an IP address and port number.

8. The communication method of claim 1, wherein the connection information further comprises encryption information.

9. A non-transitory computer readable medium storing instructions for execution on at least one computing device to configure the at least one computing device to perform a method comprising:
receiving, at a first user device, an indication of a participant for participation in a communication session;
accessing, by the first user device, at least one code contracts comprising self-executing code executing on a distributed ledger technology network (DLT) to retrieve connection information of the participant stored on the DLT; and
attempting, by the first user device, to establish a communication session with a second end user device of the participant using the retrieved connection information.

10. The computer readable medium of claim 9, wherein the method further comprises:
receiving user information of a new user, the user information including connection information for the new user;
determining an initial trust score of the new user;
accessing the at least one code contract executing on the DLT to store the user information and the initial trust score of the new user on the DLT.

11. The computer readable medium of claim 10, wherein the method further comprises:
determining a dynamic trust score of the new user based on one or more communication sessions of the user; and
accessing the at least one code contract executing on the DLT to store the dynamic trust score of the new user on the DLT.

12. The computer readable medium of claim 11, wherein determining the dynamic trust score of the new user based on one or more communication sessions of the new user comprises:
adjusting the initial trust score according to trust scores of users of successfully established communication sessions with the new user; and
adjusting the initial trust score according to trust scores of users of rejected communication sessions with the new user.

13. The computer readable medium of claim 9, wherein the method further comprises:
determining updated connection information for a particular user having user information stored on the DLT; and
accessing the at least one code contract executing on the DLT to update the connection information of the particular user stored on the DLT.

14. The computer readable medium of claim 9, wherein the communication session comprises one or more of:
a SIP based communication session;
a Voice over IP communication session;
a Video over IP communication session; and
an instant message communication.

15. The computer readable medium of claim 9, wherein the connection information comprises an IP address and port number.

16. The computer readable medium of claim 9, wherein the connection information further comprises encryption information.

17. A communication device comprising:
a processor for executing instructions;
a memory storing instructions which when executed by the processor configure the communication device to perform a method comprising:
receiving an indication of a participant for participation in a communication session;
accessing at least one code contracts comprising self-executing code executing on a distributed ledger technology network (DLT) to retrieve connection information of the participant stored on the DLT; and
attempting to establish a communication session with a second end user device of the participant using the retrieved connection information.
